(19) United States
(12) Patent Application Publication
(10) Pub. No.: US 2026/0222414 A1
(43) Pub. Date: Jul. 30, 2026

(54) COMPUTER-BASED ACCESS CONTROL OF VIRTUAL REALITY VISUAL FIELDS

(71) Applicant: INTERNATIONAL BUSINESS MACHINES CORPORATION, ARMONK, NY (US)

(72) Inventor: Meghan McGrath, Vienna, VA (US)

(21) Appl. No.: 19/040,949

(22) Filed: Jan. 30, 2025

(51) Int. Cl. H04L 9/40; G06T 15/08

(52) U.S. Cl. CPC H04L 63/105; G06T 15/08; G06T 2200/24

(57) ABSTRACT

In an approach to improve access control of virtual reality visual field, embodiments may assign characteristics to one or more voxels in reflection of an analog space within a predetermined virtual environment and the characteristics assigned to the one or more voxels within the analog space within the predetermined virtual environment to integrate the assigned characteristics in a service of user access control where a principle of least privilege is either desired or utilized for one or more regulatory reasons. Further, embodiments query a given role or access level of the characteristics and identifying contents match to predetermined viewing privileges required for the one or more voxels and responsive to identifying the contents do not match the viewing privileges, restrict, by a computing device and a user interface, a virtual display of the one or more voxels.

### BACKGROUND OF THE INVENTION

The present invention relates generally to virtual reality, and more particularly to the field of computer-based access control of virtual reality visual fields.

A voxel is a three-dimensional counterpart to a pixel. It represents a value on a regular grid in a three-dimensional space. Voxels are also commonly used in video games, both as a technological feature and a graphical style. As with pixels in a two-dimensional (2D) bitmap, voxels themselves do not typically have their position (i.e. coordinates) explicitly encoded with their values. Instead, rendering systems infer the position of a voxel based upon its position relative to other voxels (i.e., its position in the data structure that makes up a single volumetric image).

### SUMMARY

Embodiments of the present invention disclose a computer-implemented method, a computer program product, and a system, for access control of visual fields in a virtual reality context, the computer-implemented method comprising: assigning characteristics to one or more voxels in reflection of an analog space within a predetermined virtual environment; utilizing the characteristics assigned to the one or more voxels within the analog space within the predetermined virtual environment to integrate the assigned characteristics in a service of user access control where a principle of least privilege is either desired or utilized for one or more regulatory reasons; querying a given role or access level of the characteristics and identifying contents match to predetermined viewing privileges required for the one or more voxels; and responsive to identifying the contents do not match the viewing privileges, restricting, by a computing device and a user interface, a virtual display of the one or more voxels.

### BRIEF DESCRIPTION OF THE DRAWINGS

FIG. 1 is a functional block diagram illustrating a distributed data processing environment, visual field control program, in accordance with an embodiment of the present invention;

FIG. 2A illustrates one example of the visual field control program, in accordance with an embodiment of the present invention;

FIG. 2B illustrates one example of the visual field control program, in accordance with an embodiment of the present invention;

FIG. 3 illustrates operational steps of the visual field control program, on a server computer within the distributed data processing environment of FIG. 1, in accordance with an embodiment of the present invention; and

FIG. 4 illustrates operational steps of the visual field control program, on a server computer within the distributed data processing environment of FIG. 1, in accordance with an embodiment of the present invention.

### DETAILED DESCRIPTION

With the introduction of regulatory requirements like General Data Protection Regulation (GDPR), Consumer Data Protection Act (CDPA), and similar legislation across the world, embodiments recognize that there is a need for many aspects of digital activity to be reimagined in terms of access control and management. Embodiments recognize that a system, or the law may delineate who sees a particular post or photo, who sees a credit card number in the clear, who is aware of what details with a given financial transaction or set of transactions. Embodiments recognize that access management is a pre-requisite to most aspects of digital life today, whether the experience is consumer or enterprise. Embodiments recognize that the virtual reality (VR) world, however, has not yet “caught up” in this regard; like the “Internet if Things” (IoT) industry, security is often an afterthought, and the “principle of least privilege” an underemphasized component of VR architecture. Embodiments recognize that the ability to define a playspace within a VR experience is expense and time consuming in many VR systems. In various embodiments, a playspace is defined by “drawing” boundaries, or by the system detecting space in the physical environment around the player, after which the player confirms which elements of the physical room are “off limits” during play. In this way, a player can mark a nearby table as “off limits,” and the game will warn the player before they walk into or wave an arm into that table. Embodiments of the present invention recognize that some systems also have a characteristic of “soft boundary” wherein a player may be forewarned of an upcoming boundary or be slowed in progress but not stopped as they would be in a true boundary zone.

As VR is adopted into broad-scale industry use, embodiments recognize that there is a need to reflect the access control expected of many digital and analog experiences, whether driven by governing law requirements in healthcare, consumer data protection regulations that may govern a commercial VR engagement, self-enabled privacy, or any of the many confidentiality levels associated with government infrastructure.

Embodiments improve the art and solve at least the particular issues above by supporting access control for what is visible in a VR space, by leveraging existing methods with different components, and with a different purpose. Specifically, embodiments improve the art and solve at least the particular issues above by taking the workflow of delineating boundaries in a playspace (a standard feature in VR today), and assigning access authority characteristics, rather than boundary/pass-through characteristics, to voxels within a given section of the three-dimensional virtual or analog playspace. A playspace refers to a physical area within which a user can move and interact while wearing a VR headset, essentially defining the boundaries of the virtual environment they can explore within their real-world space. For example, it is the designated area where the user can walk, reach, and move around while playing a VR game or experiencing a virtual environment.

Further, embodiments improve the art and solve at least the particular issues above by (i) selecting characteristics from a list of approved roles or access levels within a predetermined virtual environment, (ii) assigning the characteristics to voxels or groups of voxels in reflection of an analog spaces within the predetermined virtual environment, (iii) utilizing the characteristics assigned to the voxels or the group of voxels within the analog spaces within the predetermined virtual environment to integrate the voxel characteristics in a service of user access control where the principle of least privilege is either desired or utilized for one or more regulatory reasons, (iv) querying a given role or access level of the characteristics and reviewing whether its contents are appropriately matched to the viewing privileges required for the voxel or groups of voxels; (v) responsive to identifying the contents do not match the viewing privileges, restricting, by the computing device and user interface, the virtual display of the voxel or groups of voxels.

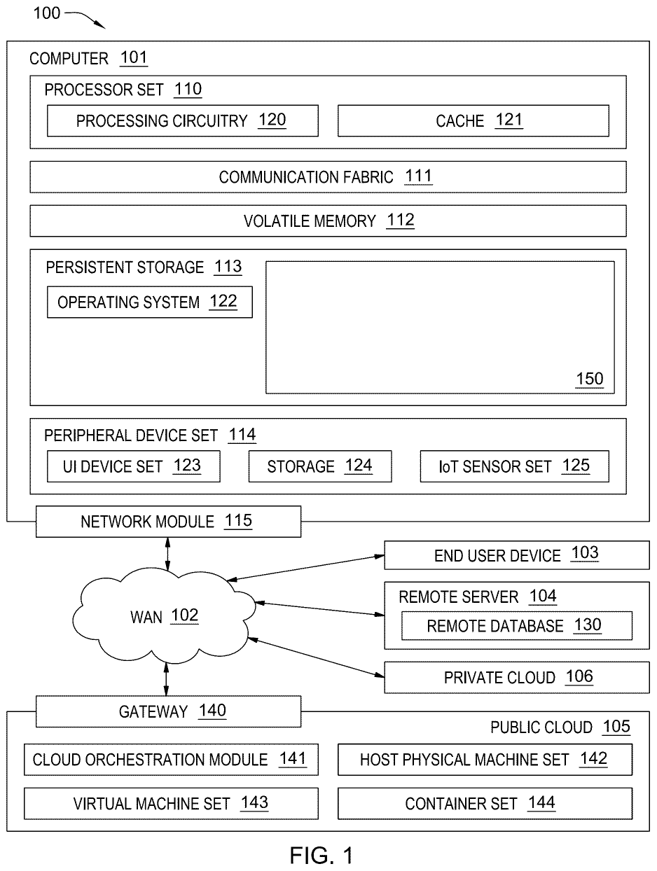

Implementation of embodiments of the invention may take a variety of forms, and exemplary implementation details are discussed subsequently with reference to the Figures (i.e., FIG. 1-FIG. 4).

It should be noted herein that in the described embodiments, participating parties have consented to being recorded and monitored, and participating parties are aware of the potential that such recording and monitoring may be taking place. In various embodiments, for example, when downloading or operating an embodiment of the present invention, the embodiment of the invention presents a terms and conditions prompt enabling the user to opt-in or opt-out of participation. Similarly, in various embodiments, emails, and texts, and/or responsive display prompts begin with a written notification that the user's information may be recorded or monitored and may be saved, for the purpose of consolidating shipments to reduce carbon emissions and shipping costs. These embodiments may also include periodic reminders of such recording and monitoring throughout the course of any such use. Certain embodiments may also include regular (e.g., daily, weekly, monthly) reminders to the participating parties that they have consented to being recorded and monitored and may provide the participating parties with the opportunity to opt-out of such recording and monitoring if desired.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

Computing environment 100 contains an example of an environment for the execution of at least some of the computer code involved in performing the inventive methods, such as visual field management program (component) 150. In addition to component 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and component 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network, or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in component 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in component 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, central processing unit (CPU) power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

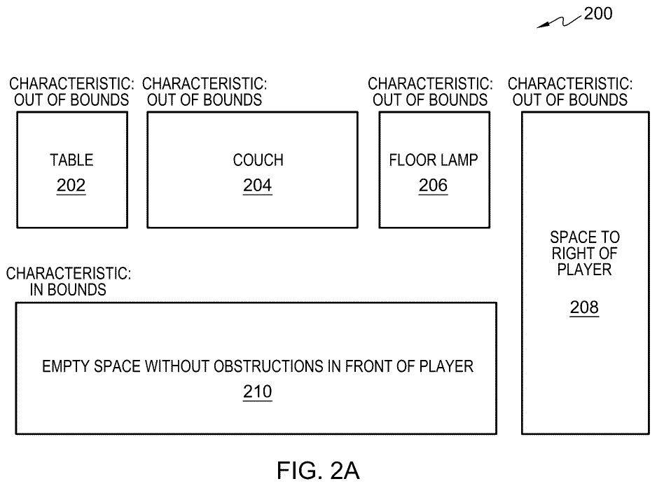

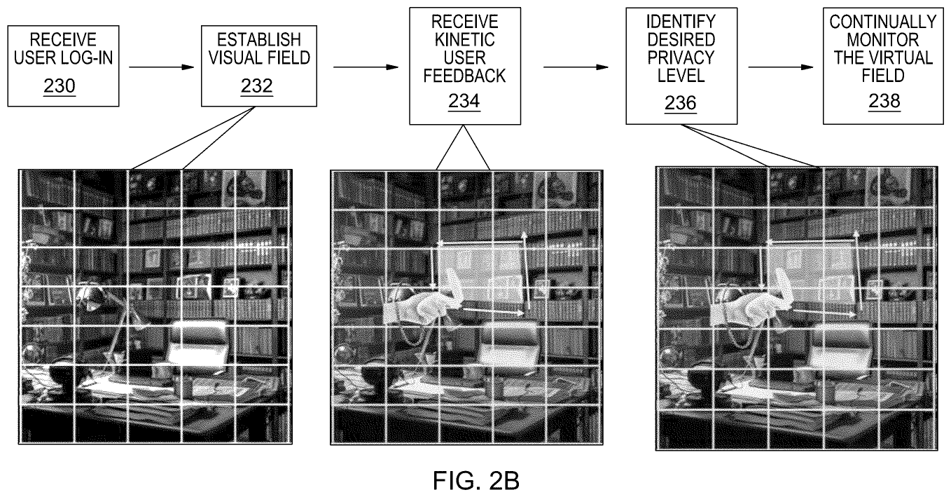

In various embodiments, the process of boundary making within VR comprises attaching a characteristic of “in-bounds” or “out-of-bounds” to a given set of voxels. In various embodiments, component 150 enables and/or facilitates access control of visual fields in a virtual reality context by attaching voxel characteristics to playspace boundaries and placing the voxel characteristics of the playspace boundaries in user access controls where the principle of least privilege (e.g., view access privilege associated with privacy) are applied. In some embodiments, component 150 places the voxel characteristics of the playspace boundaries in user access controls where the principle of least privilege is either desired or is necessary for regulatory reasons (such as General Data Protection Regulation (GDPR) or any other regulatory guidelines or regulations). For example, when a user is wearing a VR headset and/or interacting within a virtual environment through the VR or AR facilitating device, and setting playspace boundaries, the VR or AR facilitating device displays visual indicators that enable the user to visually determine the boundaries of the playspace, further discussed in FIG. 2A. Continuing this example, if the user is in a living room, then the table, couch and floor lamp will be out-of-bounds; however, the physical floor space is in-bounds (part of the playspace) and contains a specific predetermined visual designation (i.e., a predetermined indicator that enables the differentiation of in-bound versus out-of-bound areas regarding the playspace).

In various embodiments, component 150 enables and/or facilitates a virtual telemeeting with a client in a virtual workspace, knowing that sensitive data on the team's virtual wall of work will not be visible. A virtual physical trainer may be able to meet with a client in a space where personal identifiable information (PII) data is obscured by default, lowering any regulatory risk the trainer may incur during the meeting with respect to personal data handling. Component 150 may identify corresponding use in the VR space of selectively obscured data in a two-dimensional web interaction according to user privilege.

Component 150 improves the art and solve at least the particular issues above by (i) selecting characteristics from a list of approved roles or access levels within a predetermined virtual environment, (ii) assigning the characteristics to voxels or groups of voxels in reflection of an analog spaces within the predetermined virtual environment, (iii) utilizing the characteristics assigned to the voxels or the group of voxels within the analog spaces within the predetermined virtual environment to integrate the voxel characteristics in a service of user access control where the principle of least privilege is either desired or utilized for one or more regulatory reasons, (iv) querying a given role or access level of the characteristics and reviewing whether its contents are appropriately matched to the viewing privileges required for the voxel or groups of voxels; (v) responsive to identifying the contents do not match the viewing privileges, restricting, by the computing device and user interface, the virtual display of the voxel or groups of voxels.

In various embodiments, component 150 utilizes the workflow of boundary-setting in virtual spaces; however, instead of assigning boundary/pass-through characteristics to voxels (as is done with boundary-setting), component 150 proposes the assigning of access control characteristics. In various embodiments, according to the need of the specific platform, the characteristics comprise: a set of user roles that can be assigned, elevated, decreased, or revoked; an access or security level that likewise can be assigned, elevated, decreased, or revoked; and/or follow an internal standard for access control set by the company. In various embodiments, component 150 sets access privilege for a session within the virtual environment.

FIG. 2A illustrates one example of component 150, imbuing voxels in playspace with boundary characteristics, in accordance with an embodiment of the present invention. Boundary characteristics comprise but are not limited to whether an object is in-bounds or out-of-bounds, viewing access, username, quality of access, and/or PII indication (e.g., whether an identified PII item is viewable by a user and/or secondary user. In this particular example, playspace 200 comprises table 202, couch 204, floor lamp 206, space 208, and open space 210. In this example playspace 200 is a physical room. In one example, table 202 contains photographs of loved ones that either the player, the system, or the law considers PII in certain contexts (e.g., visiting with a telemedicine provider, virtually meeting with a contractor for construction quote, etc.). In this example, component 150 continuously monitors playspace 200, via IoT sensors (e.g., a camera feed physically or digitally connected to the VR system) for objects that may be deemed or labeled as out-of-bounds (e.g., any personal or sensitive information).

In various embodiments, component 150 adds characteristics around in-boundness and out-of-boundness (e.g., objects or individual users that are identified as being in-bound or out-of-bound in relation to a playspace). In various embodiments, the characteristics assigned/added may are based on different assignations that are affiliated with different regional or industry frameworks (e.g. local, federal, and/or international policy rules and regulations). In various embodiments, language around the characteristics being able to be defined by the sensitivity definitions of a variety of industry-and regionally specific standards. Other characteristics that may be leveraged by component 150 comprise, but are not limited to, geospatial data, IP address, and network information. In some embodiments, component 150 receives and recognizes brain computer interface (BCI) inputs.

In various embodiments, component 150 performs automated analogous substitution, wherein the voxels that comprise an object that falls under PII or a similar category (e.g., a family photograph or a classified document that is present in the virtual workspace) is automatically substituted for a generic and similar common place object. For example, instead of displaying the family photograph a generic photograph from the public domain will be displayed instead or instead of displaying the confidential document a blank book, a calendar, notepad, or blank document will be displayed. In various embodiments, analogous substitution is generated via a diffusion model, generative adversarial networks (GANs), and/or variational autoencoders (VAEs). In various embodiments, component 150 utilize the identified object and context of the identified object to identify an analogous substitution for an object. In some embodiments, component 150 utilizes the identified object and context of the identified object to search the global wide area network (WAN) to identify an analogous substitution for an object.

In this particular example, component 150 characterizes the voxels affiliated with where table 202 sits within playspace 200 with access control attributes in addition to boundary attributes. In various embodiments, characterizing the voxels affiliated where an object sits within playspace 200 comprises: (i) receiving from a system administrator access-based roles that will define the system, whether through coding explicit definitions will be input into the system directly or by inheriting a set of organizational, regional, or industry standards or other set of pre-established role definitions, (ii) defining the relationships between the access-based roles, and (iii) establishing a library of potential actions by being explicitly hard-coded in, inherited from existing standards, and/or taken from a pre-exiting available library.

In various embodiments, component 150 defines the relationships between the access-based roles in the same manner as the defined access-based roles. For example, if user x who has been assigned to role A generates, owns, or manages a set of voxels that are then within the visible field of user y who has been assigned to role B, then (i) no action occurs meaning the item appears to user in role B exactly as it appears to user in role A, (ii) a blurring/blocking action is applied to the object, or (iii) automatic analogous substitution will be performed, wherein the item which the user in role B does not have access to view will be replaced automatically in the visual field by a similar/analogous generic item that has been generated for visually replacing the object when displayed to the user in role B.

In various embodiments, responsive to defining the roles and relationships between the access-based roles, component 150 establishes a library of potential actions by being explicitly hard-coded in, inherited from existing standards, and/or taken from a pre-exiting available library. In some embodiments, the parameters for a given system comprise an explicit definition assigned to the range of allowance for the volume and dimensions of the generic substitution item in the visual field, any material requirements (e.g., liquid/solid/gas in relation to the surrounding environment), rate of refresh, conditions of refresh, and any required indications or signature to make clear that it is in fact a substitution, if legal, ethical or other requirement deems that distinction necessary.

In this particular example, table 202, couch 204, floor lamp 206, and space 208 are considered out-of-bounds for the user in regard to playspace 200. In various embodiments, component 150 assigns characteristics to voxels in reflection of analog spaces, however the exact technique may also be used to assign these same characteristics to virtual. In various embodiments, on the administrative side, component 150 queries a given role or access level and reviews whether the content matches to the viewing privileges required for that category. In various embodiments, component 150 comprises overriding capabilities and flagging capabilities to predict that a physical object and/or characteristics of the physical object are improperly scoped (e.g., an item that is frequently covered by GDPR is in the clear and so a different level of access should potentially be assigned).

FIG. 2B illustrates one example of component 150, imbuing voxels in playspace with boundary characteristics through a haptic/kinetic workflow, in accordance with an embodiment of the present invention.

In various embodiments, component 150 enables a user to intuitively specify the privacy/classification levels of the objects in a physical workspace when setting up a VR environment. For example, in the depicted embodiment, component 150 receives user log-in 230 from a user interface (UI). In the depicted embodiment, component 150 establishes visual field 232. In various embodiments, responsive to receiving user log-in 230, component 150 150 establishes visual field 232 of a physical space that will be implemented into a virtual environment via virtual reality, augmented reality, or mixed reality.

In the depicted embodiment, component 150 receives kinetic user feedback 234. In various embodiments, component 150 is connected to a user interface that enables the user to interact with the physical world and virtual world. In various embodiments, component 150 receives user feedback (e.g., kinetic or motion derived feedback) of selected objects in a physical workspace from the user. For example, a user physically taps or touches a family photograph in their office to set a privacy level or classification level of the family photograph. In various embodiments, user feedback is executed and generated from kinetic capturing sensors, motion sensors, haptic sensors and/or any other sensors known and understood in the art that capture kinetic motion or gesturing from the user. In some embodiments, the received user feedback may be a gesture or motion of the hands or body instead of a physical touch. In various embodiments, a user gestures to outline a visual space to add additional access control within the playspace or current environment to establish a VR environment. For example, a user gestures by motioning their hand to draw an outline around a set of photographs on a bookshelf to create a visual space with additional access control around the set of photographs.

In the depicted embodiment, component 150 identifies a desired privacy level 236. In various embodiments, based on the received user feedback, component 150 identifies desired privacy level 236 of the one or more selected objects based on received user feedback (e.g., kinetic user feedback 234) and/or predetermined settings. For example, the privacy level of an object may be set as either (i) non-sensitive, wherein a privacy level (i.e., classification) of non-sensitive means an object may be seen by all other users, (ii) sensitive, wherein a privacy level of sensitive means an object may only be seen by user with permission, or (iii) classified, wherein a privacy level of classified means an object is not visible to any user except the primary user (i.e., the user who owns the object). In this example, a user selects objects in a current physical or virtual environment and touches (e.g., taps) each object to set the privacy level. In this example, a single tap corresponds to non-sensitive privacy level, a double tap sets the privacy level of the object to sensitive, and tapping an object three times sets the privacy level of the object to classified. Continuing the set of photographs example above, the user utilizes the UI and haptic system to tap the set of photographs within the created visual space to set the privacy level to sensitive.

In the depicted embodiment, component 150 continually monitors the virtual field of virtual space 238. In various embodiments, component 150 continually monitors a user's (e.g., first user) virtual space and any interactions with other users (i.e., second users) and dynamically adjusts objects in the first user's virtual space based on the identified privacy level of the objects. In various embodiments, if objects in a virtual space are designated/classified as sensitive or confidential, component 150 performs analogous substitution of the object using an AI-generated visual filler. In various embodiments, based on the identified privacy level of objects in a virtual space, component 150 will generate, via a GAN or diffusion model, a new object to display to one or more second users instead of displaying the original. For example, a user selects a set of government paperwork on a desk and sets the privacy setting to classified. In this example, the user enters into a virtual telehealth appointment with a physician, in which the physician is able to view the user's virtual space including the desk with the documents. In this example, since the documents have been designated as confidential, component 150 will generate and display a book instead of the documents the physician.

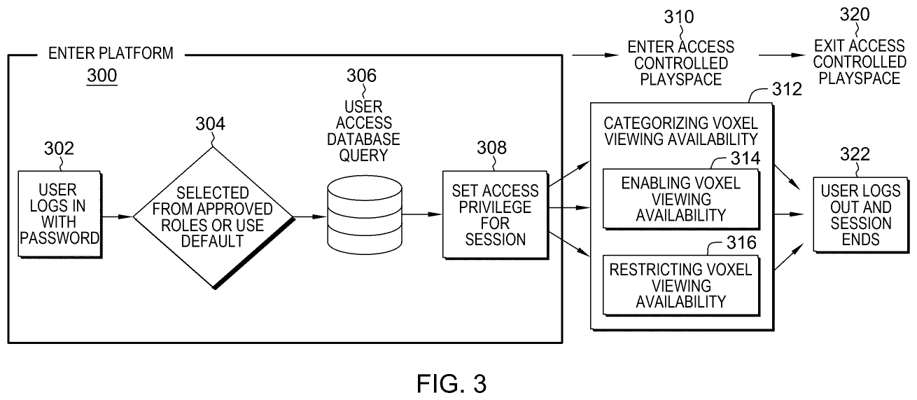

FIG. 3 illustrates operational steps of component 150, generally designated 300, in communication with client computer 101, remote server 104, private cloud 106, EUD 103, and/or public cloud 105, within distributed data processing environment 100, for representing an access management user flow, in accordance with an embodiment of the present invention. FIG. 3 provides an illustration of one implementation and does not imply any limitations with regard to the environments in which different embodiments may be implemented. Many modifications to the depicted environment may be made by those skilled in the art without departing from the scope of the invention as recited by the claims.

In the depicted embodiment, the access management flow comprises are three components (i) enter platform 300, (ii) enter access controlled playspace 310, and (iii) exit access controlled playspace 320. In the depicted embodiment, enter platform 300 comprises user login with password 302, role selection 304, user access database query 306, and set access privilege 308. In the depicted embodiment, component 150 receives a user login with password 302, where a role is assigned or selected from a list of approved roles, or a predetermined default role is assigned or selected. In the depicted embodiment, component 150 identify and selects a role 304 from a predetermined list of predetermined roles.

In the depicted embodiment, component 150 utilizes user login with password 302 to query user access database 306. In various embodiments, user login is a standard login procedure with role-based access control, as it is known and understood in the art, wherein a user attempts to access a system with a username and password and in some instances other forms of authentication. The system data is matched with a system database of user information that includes the role assigned to that user which will dictate the level of access they will be given during their logged-in session.

In the depicted embodiment, responsive to successfully querying user access database 306, component 150 sets access privilege for session 308. In various embodiments, component 150 sets user access levels according to a role affiliated with a user identification (ID) element (e.g., ID number) and the access levels assigned to various roles by a particular organization.

In the depicted embodiment, enter access-controlled space 310 comprises categorizing voxel viewing availability 312, wherein categorizing voxel viewing availability 312 comprises enabling voxel viewing availability 314 and restricting voxel viewing availability 316. In various embodiments, categorizing voxel viewing availability 312 comprises categorizing one or more voxels in a playspace into unrestricted voxels, specialized voxels, or restricted voxels. In various embodiments, component 150 identifies a desired privacy level of the one or more selected objects within a virtually shared space based on received user feedback (e.g., kinetic user feedback) and/or predetermined settings. For example, a user selects objects in a current physical or virtual environment and touches (e.g., taps) each object to set the privacy level. In various embodiments, component 150 categorizes/identifies whether a voxel is restricted, specialized, or unrestricted through gestural assignation, within a mode of the VR experience where editing or setup is enabled in which enables a user to outline an object in view using the console in their hands, and attribute to the outlined object the desired characteristics of access. In various embodiments, the outline may adjust to the intended object using an algorithmic estimate of what was intended exactly with the more rudimentary circling of the object with hand consoles or haptics associated with a UI. In various embodiments, component 150 provides affordances for a user to retry an attempt of outlining an object for undesired results. In various embodiments, component 150 enables an automatic assignations of access control to objects. For example, a first user with role A causes a photograph to enter the visual field—whether originating from their physical environment as in an AR experience or generated by them in some capacity in a VR experience—the photograph will automatically be something that a second user with role B cannot see (e.g., obscured, blurred, or substituted for a generic form or other object).

In various embodiments, enabling voxel viewing availability 314 comprises enabling a user to view all available voxels or enable a user to view only a selected number of voxels (e.g., a portion of voxels or specialized voxels). In various embodiments, specialized voxels refers to the voxels that have been assigned role-based access characteristics (e.g., assigned security or sensitivity levels that require a predetermined level or permission to access) and thereby exhibit characteristics of view ability (they are blocked, blurred, or automatically substituted). In various embodiments restricting voxel viewing availability 316 comprises restricting voxel viewability to one or more users. In various embodiments, enabling voxel viewing availability 314 and restricting voxel viewing availability 316 enable the viewing of unrestricted and specialized voxels and restrict the viewing of restricted voxels to one or more users. An unrestricted voxel is a voxel in a playspace that comprises no viewing restrictions. In various embodiments, restricted voxels are blurred, replaced with generic imagery, or otherwise rendered to mask PII or regulated virtual visual material.

For example, a physician who meets with patients virtually in an office has a photograph of their home with family members standing in front of it. This photograph may originate from the physician's physical office space, as in an AR experience, or uploaded into their space as a VR experience. In this example, when a new patient comes in with low levels of access to PII, the photogram in the frame will appear blurred, as a blank in some pre-established way, as a generic stock photograph in the public domain, or as a generated generic image to the patient. In various embodiments, the generated generic image is generated by a diffusion model or GAN, wherein the sensitive or classified objects are identified through image recognition or explicit definition and the security or privacy status is established through explicit creation or automatic means. In some embodiments, a prompt indicating identified potentially sensitive or confidential objects are generated and presented to a user. For example, component 150 would identify a photograph of a house with a family or a document with an address or phone number as being an object with potential sensitive or confidential information and would prompt the user to set the privacy level (e.g., PII status) or automatically set the privacy level based on predetermined settings. In various embodiments, a prompt indicating a potentially sensitive object or object containing sensitive data is fed into a diffusion model or utilized by a GAN from which a generic image is created to replace the original object within the viewing field of a second user. In some embodiments, a generic image can be a related image or analogous image that fits within predetermined parameters of identified context. In some embodiments, the generated generic image is stored and repopulated and displayed to the second user when the second user is within the visual space. In some embodiments, the generated generic image is uniquely labeled and associated to a particular second user and is displayed, instead of the original object, to the second user when a second user is within the visual space.

In the depicted embodiment, exit access controlled playspace 320 comprises user ends session 322. In various embodiments, component 150 receives user log out instructions and ends session 322. In various embodiments, ending session 322 comprises logging a user out of the user login session 302 and storing the categorized voxels and voxel viewing availability permission (e.g., restricted or unrestricted voxels). In some embodiments, the voxel viewing availability permission is retrieved from a databased and autoloaded in other user sessions in the playspace.

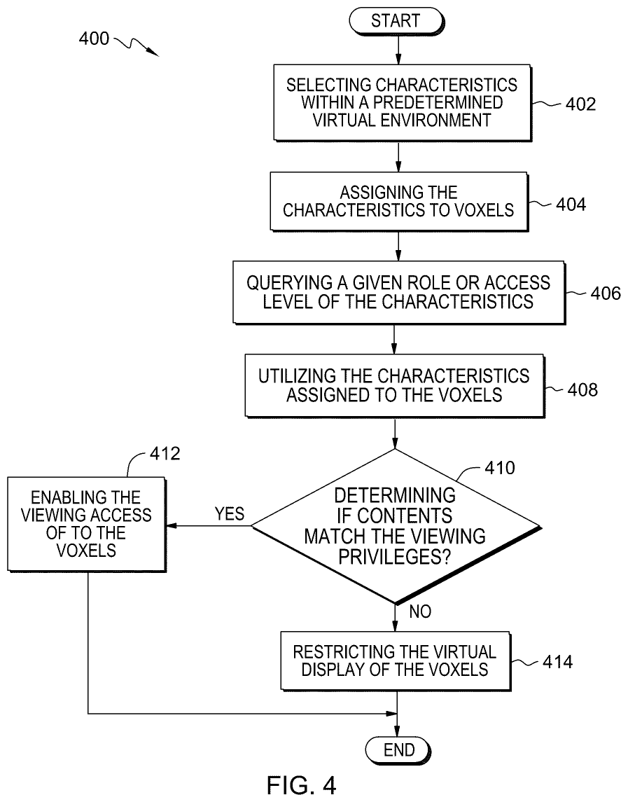

FIG. 4 illustrates operational steps of component 150, generally designated 400, in communication with client computer 101, remote server 104, private cloud 106, EUD 103, and/or public cloud 105, within distributed data processing environment 100, for access control of visual fields in a virtual reality context. FIG. 4 provides an illustration of one implementation and does not imply any limitations with regard to the environments in which different embodiments may be implemented. Many modifications to the depicted environment may be made by those skilled in the art without departing from the scope of the invention as recited by the claims.

In block 402, component 150 selects characteristics of objects within a predetermined virtual environment. In various embodiments, component 150 selects characteristics from a list of approved roles or access levels within a predetermined virtual environment. In various embodiments, a user or a system (e.g., component 150) establishes whether an object is sensitive (e.g., PII) or not sensitive (e.g., requires no security or access restrictions) and defines a level of access to sensitive objects required by second/other users. In various embodiments, component 150 receives and executes instructions on selected behaviors to perform that corresponds to an objects viewability associated with the defined level of access. For example, determining whether to blank out an object, not display the object, or substitute the original object with a generic object.

In one example, a physician establishes a virtual office based on their physical office and circles, through a UI using a gestural movement with the hand console with the intent to assign special characteristics to the voxels comprising those objects, three photographs, a graduation diploma, and a map of their home city on a wall in the background. In this example, the physician assigns a high level of privacy to the photographs meaning they are only viewable by trusted associates with an appropriate degree of expressed access, a medium level of privacy to the diploma which contains PII meaning the diploma is only visible to users with a medium level trust score or higher, and a lower level of privacy, in relation to the diploma, meaning the map is visible to all user with a baseline level of trust or higher. Levels of trust would be determined according to predetermined metrics or predetermined factors (e.g., time known, explicitly stated relationship, pre-set designation, or custom pre-set designation). In the above example, objects are assigned as viewable (or not) according to levels of magnitude of access by a fellow user, but this could also be defined by organizational roles (managers can see this, auditors can see this, test teams can see this, etc.) or by an object-first definition (this photograph is marked as “High PII Concern,” “Med PII Concern,” “Low PII Concern,” or with some other taxonomy.)

In block 404, component 150 assigns the characteristics to voxels. In various embodiments, assigns the characteristics to voxels in a playspace. In various embodiments, a user establishes virtual office based on their physical office and circles, through a UI, objects in the virtual environment using a gestural movement with the hand console with the intent to assign special characteristics to the voxels comprising those objects. In various embodiments, the selected characteristics are assigned to the objects, wherein component 150 automatically adjusts the viewability of selected objects, when displayed to/viewed by other users, based on the assigned characteristics, trust level, and/or context of user interaction when another user is present in the virtual environment. In various embodiments, categorizing voxel viewing availability comprises categorizing one or more voxels in a playspace into unrestricted voxels, specialized voxels, or restricted voxels. In various embodiments, component 150 identifies a desired privacy level of the one or more selected objects within a virtually shared space based on received user feedback (e.g., kinetic user feedback) and/or predetermined settings. For example, a user selects objects in a current physical or virtual environment and touches (e.g., taps) each object to set the privacy level. In various embodiments, component 150 categorizes/identifies whether a voxel is restricted, specialized, or unrestricted through gestural assignation, within a mode of the VR experience where editing or setup is enabled in which enables a user to outline an object in view using the console in their hands, and attribute to the outlined object the desired characteristics of access.

In block 406, component 150 queries a given role or access level of the characteristics. In various embodiments, component 150 queries a given role or access level of the characteristics to provide supporting information architecture for a particular platform. The querying collects supporting data to enable the generation of a virtual collaboration environment based on assigned characteristics and access levels. For example, when user y enters a virtual space (the virtual office of user x), the viewable space is generated and presented according to the already established security requirements of the objects in the space and the access privileges of user y.

In block 408, component 150 utilizes the characteristics assigned to the voxels. In various embodiments, component 150 utilizes the characteristics assigned to the voxels. For example, user x and user y, two individuals occupying different locations in space (whether a few feet away or over many time zones), share a single VR space which largely looks and acts the same for both (in this example). In this example, user x and user y are meeting user x's office and thus component 150 visually displays, through VR glasses or another display medium known and used in the art, all the objects and photographs as they appear in their original state in the office with no extra work happening on the back end of the system to present them visually in any special way. Continuing this example, for user y with role B, who does not have full access to all of the PII visible in the shared space, such as some user x's photographs and objects have been replaced by analogous substitutes; meaning the voxels have been altered to appear as a generic substitute and so while user y sees photographs and objects in the room, those photographs were generic and created by AI, and do not contain sensitive information associated with user x. In doing so, in this example, component 150 may executes extra steps and uses extra resources in organizing the visual space presented to user y.

In block 410, component 150 determines if the contents match the viewing privileges. In various embodiments, component 150 determines whether the contents match the viewing privileges. In the depicted embodiment, if component 150 determines the contents match the viewing privileges (Yes Step) then component 150 advances to block 412. However, in the depicted embodiment, if component 150 determines the contents do not match the viewing privileges (No Step) then component 150 advances to block 414.

In block 412, component 150 enables the viewing access of the voxels to a user. In various embodiments, responsive to the contents of the viewing privileges matching the viewing privileges, component 150 enables the viewing access of the voxels in the playspace to a user. In various embodiments, if a visiting user (i.e., second or secondary user) has a trust level at or above a pre-established trust requirement or has received permission from a hosting user (i.e., first user) for identified sensitive or classified objects then those objects in the virtual space of the first user will appear as they are without any substitution or blur. For example, a first user selects and classifies medical documents as sensitive, but grants access a second user who is his physician then when they meet for a telehealth check-in hosted by the first user the medical documents on the first user's desk will be visible to the second user.

In block 414, component 150 restricts the viewing access of the voxels to a user. In various embodiments, responsive to the contents of the viewing privileges not matching the viewing privileges, component 150 restricts the viewing access of the voxels in the playspace to a user. In various embodiments, responsive to identifying that the contents do not match the viewing privileges, component 150 flags and label the voxel or groups of voxels for restriction and voxels presented are presented in a different form (blurred, substituted, etc.) as determined above or predetermined by the user or system.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

Computer readable program instructions described herein may be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, may be implemented by computer readable program instructions.

These computer readable program instructions may be provided to a processor of a general-purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that may direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

The flowchart and block diagrams in the Figures (i.e., FIG.) illustrate the architecture, functionality, and operation of possible implementations of systems, methods, and computer program products according to various embodiments of the present invention. In this regard, each block in the flowchart or block diagrams may represent a module, a segment, or a portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, may be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method comprising:
assigning characteristics to one or more voxels in reflection of an analog space within a predetermined virtual environment;
utilizing the characteristics assigned to the one or more voxels within the analog space within the predetermined virtual environment to integrate the assigned characteristics in a service of user access control where a principle of least privilege is either desired or utilized for one or more regulatory reasons;
querying a given role or access level of the characteristics and identifying contents match to predetermined viewing privileges required for the one or more voxels; and
responsive to identifying the contents do not match the viewing privileges, restricting, by a computing device and a user interface, a virtual display of the one or more voxels.

2. The computer-implemented method of claim 1, further comprising:
selecting characteristics from a list of approved roles or access levels within a predetermined virtual environment;
setting access privilege for a session within the virtual environment; and
identifying and selecting a role from a predetermined list of predetermined roles.

3. The computer-implemented method of claim 1, wherein restricting the virtual display of the one or more voxels further comprising:
performing automated analogous substitution on one or more object within the one or more voxels.

4. The computer-implemented method of claim 3, wherein performing automated analogous substitution comprises:
utilizing an identification of the one or more objects within the one or more voxels and context associated with the identified one or more objects within the one or more voxels to identify an analogous substitution for the one or more objects within the one or more voxels; and
generating and displaying the analogous substitution to a second user.

5. The computer-implemented method of claim 1, further comprising:
setting user access levels according to a role affiliated with a user identification (ID) element and access levels assigned to various roles by a particular organization.

6. The computer-implemented method of claim 1, further comprising:
dynamically adjusting objects in a virtual space of a user based on an identified privacy level of the objects.

7. The computer-implemented method of claim 1, wherein assigning the characteristics to the one or more voxels further comprises:
receiving, by a user interface, user feedback of selected objects in a physical workspace from the user, wherein the user feedback is executed through kinetic motion or gesturing by the user.

8. A computer system comprising:
one or more computer processors;
one or more computer readable storage devices; and
program instructions stored on the one or more computer readable storage devices for execution by at least one of the one or more computer processors, the stored program instructions comprising:
program instructions to assign a characteristics to a one or more voxels in reflection of an analog space within a predetermined virtual environment;
program instructions to utilize the characteristics assigned to the one or more voxels within the analog space within the predetermined virtual environment to integrate the characteristics of the one or more voxels in a service of user access control where a principle of least privilege is either desired or utilized for one or more regulatory reasons;
program instructions to query a given role or access level of the characteristics and identifying contents match to predetermined viewing privileges required for the one or more voxels; and
responsive to identifying the contents do not match the viewing privileges, program instructions to restrict, by a computing device and a user interface, a virtual display of the one or more voxels.

9. The computer system of claim 8, further comprising:
program instructions to select characteristics from a list of approved roles or access levels within a predetermined virtual environment;
program instructions to set access privilege for a session within the virtual environment; and
program instructions to identify and select a role from a predetermined list of predetermined roles.

10. The computer system of claim 8, wherein restricting the virtual display of the one or more voxels further comprising:
program instructions to perform automated analogous substitution on one or more object within the one or more voxels.

11. The computer system of claim 10, wherein performing automated analogous substitution comprises:
program instructions to utilize an identification of the one or more objects within the one or more voxels and context associated with the identified one or more objects within the one or more voxels to identify an analogous substitution for the one or more objects within the one or more voxels; and
program instructions to generate and display the analogous substitution to a second user.

12. The computer system of claim 8, further comprising:
program instructions to set user access levels according to a role affiliated with a user identification (ID) element and access levels assigned to various roles by a particular organization.

13. The computer system of claim 8, further comprising:
program instructions to dynamically adjust objects in a virtual space of a user based on an identified privacy level of the objects.

14. The computer system of claim 8, wherein assigning the characteristics to the one or more voxels further comprises:
program instructions to receive, by a user interface, user feedback of selected objects in a physical workspace from the user, wherein the user feedback is executed through kinetic motion or gesturing by the user.

15. A computer program product comprising:
one or more computer readable storage devices and program instructions stored on the one or more computer readable storage devices, the stored program instructions comprising:
program instructions to assign a characteristics to a one or more voxels in reflection of an analog space within a predetermined virtual environment;
program instructions to utilize the characteristics assigned to the one or more voxels within the analog space within the predetermined virtual environment to integrate the characteristics of the one or more voxels in a service of user access control where a principle of least privilege is either desired or utilized for one or more regulatory reasons;
program instructions to query a given role or access level of the characteristics and identifying contents match to predetermined viewing privileges required for the one or more voxels; and
responsive to identifying the contents do not match the viewing privileges, program instructions to restrict, by a computing device and a user interface, a virtual display of the one or more voxels.

16. The computer program product of claim 15, further comprising:
program instructions to select characteristics from a list of approved roles or access levels within a predetermined virtual environment;
program instructions to set access privilege for a session within the virtual environment; and
program instructions to identify and select a role from a predetermined list of predetermined roles.

17. The computer program product of claim 15, wherein restricting the virtual display of the one or more voxels further comprising:
program instructions to perform automated analogous substitution on one or more object within the one or more voxels, wherein performing automated analogous substitution comprises:
program instructions to utilize an identification of the one or more objects within the one or more voxels and context associated with the identified one or more objects within the one or more voxels to identify an analogous substitution for the one or more objects within the one or more voxels; and
program instructions to generate and display the analogous substitution to a second user.

18. The computer program product of claim 15, further comprising:
program instructions to set user access levels according to a role affiliated with a user identification (ID) element and access levels assigned to various roles by a particular organization.

19. The computer program product of claim 15, further comprising:
program instructions to dynamically adjust objects in a virtual space of a user based on an identified privacy level of the objects.

20. The computer program product of claim 15, wherein assigning the characteristics to the one or more voxels further comprises:
program instructions to receive, by a user interface, user feedback of selected objects in a physical workspace from the user, wherein the user feedback is executed through kinetic motion or gesturing by the user.
